(19) United States
(12) Patent Application Publication
(10) Pub. No.: US 2004/0037620 A1
(43) Pub. Date: Feb. 26, 2004

(54) Ball joint

(76) Inventor: Peter Bernhardt, Wuppertal (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/634,235

(22) Filed: Aug. 5, 2003

(30) Foreign Application Priority Data
Aug. 12, 2002 (DE) 202 12 385.5

(51) Int. Cl. F16D 1/12

(52) U.S. Cl. 403/134

(57) ABSTRACT

A ball joint comprises a housing, a ball stud and a sealing bellows which lies against the housing and the ball stud in order to seal between them. The ball stud has a holding surface, against which a sealing surface of the sealing bellows lies. The sealing surface, when not being deformed and as seen along a longitudinal axis of the ball stud, is longer than the holding surface.

### TECHNICAL FIELD

The invention relates to a ball joint.

### BACKGROUND OF THE INVENTION

A ball joint usually comprises a housing, a ball stud and a sealing bellows which lies against the housing and the ball stud in order to seal between them.

According to prior art, the sealing bellows is placed on the pin side into a groove and is fastened and held by means of a clamping ring. Hitherto, the pin groove which is necessary for this has been produced by a separate operating step, for example by machining, rolling or the like.

The object of the invention consists in further developing a ball joint of the type initially mentioned, to the effect that lower manufacturing costs and an improved sealing are the result.

### BRIEF SUMMARY OF THE INVENTION

According to the invention, a ball joint comprises a housing, a ball stud and a sealing bellows which lies against the housing and the ball stud in order to seal between them. The ball stud has a holding surface, against which a sealing surface of the sealing bellows lies. The sealing surface, when not being deformed and as seen along a longitudinal axis of the ball stud, is longer than the holding surface. The invention is based on the fundamental concept of generating the necessary pre-tension between the sealing bellows and the ball stud in that the sealing surface of the sealing bellows, on installation of the ball stud, is pressed together in axial direction at its later place of destination. The term “unformed state” refers here to the state of rest before installation in the vehicle. According to the invention, a clamping ring which firmly clamps the sealing bellows on the ball stud is not absolutely necessary. The ball stud groove, which hitherto had to be produced entailing expense, can also be saved. Furthermore, a simplified installation process results, because the sealing bellows no longer has to be positioned in a defined manner in the groove in the pin, but rather merely has to be pushed onto the holding surface.

According to the preferred embodiment of the invention, provision is made that the holding surface and the sealing surface are cylindrical. A cylindrical holding surface can be produced with minimal expenditure.

Preferably, provision is made that a contact surface for a component is provided so as to adjoin the holding surface on its side facing away from the housing, the ball stud being adapted to be mounted to the component. In this way, on installation, an additional defined axial pre-stressing of the sealing bellows on the ball stud is achieved, because the final position of the pin on the component is precisely defined by the contact surface. Hereby, in addition, a sealing effect is achieved in axial direction, which represents an improvement compared with the conventional radial groove seals.

Provision can be made that the sealing bellows is provided with a metal ring, which acts upon the sealing surface against the holding surface. In this way, the radial pre-stressing can be varied.

According to the preferred embodiment of the invention, the sealing bellows is dimensioned such that it can not slip off from the holding surface when the ball joint is not arranged on a component. This ensures that before the installation of the ball stud, the sealing surface of the sealing bellows is situated, correctly arranged and guided, on the holding surface of the ball stud.

### BRIEF DESCRIPTION OF THE DRAWINGS

FIG. 1 shows in a sectional view a ball joint according to the invention, before installation on a component; and

FIG. 2 shows in a sectional view the ball joint of FIG. 1 installed on a component.

### DETAILED DESCRIPTION OF THE PREFERRED EMBODIMENT

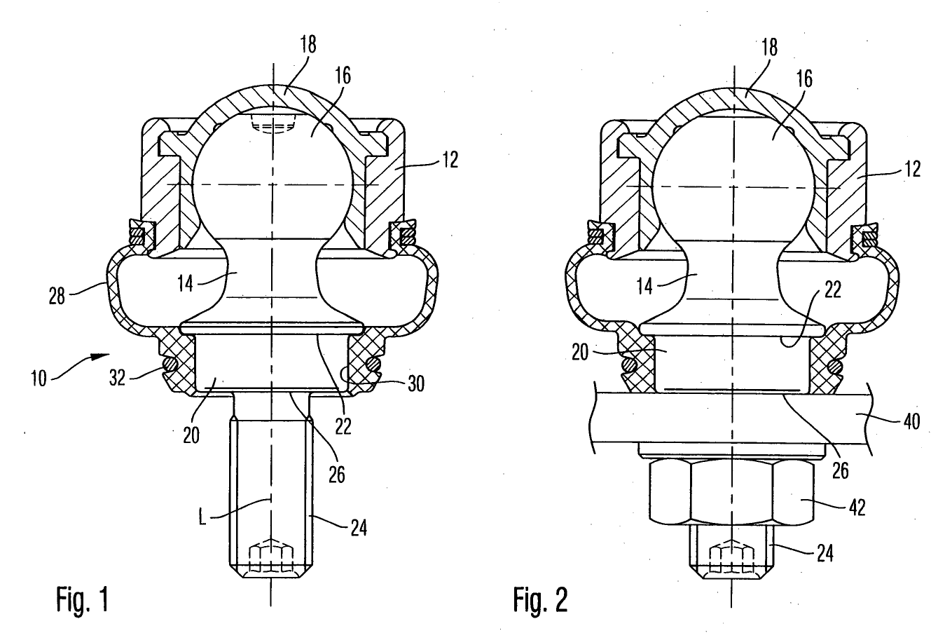

In FIG. 1 a ball joint 10 is shown, which has as essential components a housing 12 and a ball stud 14. The ball stud 14 has a ball head 16, which is arranged in a shell 18 which in turn is secured in the housing 12. The ball stud 14 additionally has a cylindrical holding surface 20, which is delimited towards the ball head 16 by a shoulder 22, and also has a thread 24. Between the thread 24 and the holding surface 20, a contact surface 26 is formed.

A sealing bellows 28 is provided, which with respect to FIG. 1 is attached on its upper side to the housing 12. On its lower side with respect to FIG. 1, the sealing bellows 28 is provided with a cylindrical sealing surface 30, which is arranged on the holding surface 20 of the ball stud 14. As can be seen in FIG. 1, the sealing surface 30 projects slightly beyond the holding surface 20 in axial direction with respect to the longitudinal axis L of the ball stud, because it is longer than the holding surface 20, as viewed in axial direction. The sealing bellows is provided with a metal ring 32, which urges the sealing surface 30 of the sealing bellows 28 against the holding surface 20 of the ball stud 14.

In FIG. 2 the ball joint 10 is shown, arranged on a component 40, which for example is a part of a chassis for a motor vehicle. The ball stud 14 is inserted with its thread 24 through the component 40 and is fastened thereon by means of a nut 42. In so doing, the component 40 lies against the contact surface 26 of the ball stud 14. On installation, the part of the sealing bellows 38 arranged on the holding surface 20 is compressed in axial direction, because it is pressed by the component 40 against the shoulder 22 on the ball stud 14. In so doing, the sealing surface 30 of the sealing bellows 28 is also firmly pressed against the holding surface 20, so that a reliable sealing is ensured.

The dimensions of the sealing bellows 28 are selected such that the section of the sealing bellows arranged on the holding surface 20 can not slip off from the holding surface 20 in the direction towards the thread 24, as long as the ball joint 10 is not mounted on a component; in this way, the corresponding section of the sealing bellows is retained.

1. A ball joint comprising a housing, a ball stud and a sealing bellows which lies against said housing and said ball stud in order to seal between them, said ball stud having a holding surface against which a sealing surface of said sealing bellows lies, and said sealing surface, when not being deformed and as seen along a longitudinal axis of said ball stud, being longer than said holding surface.

2. The ball joint according to claim 1, wherein said holding surface and said sealing surface are cylindrical.

3. The ball joint according to claim 1, wherein a contact surface for a component is provided so as to adjoin said holding surface on its side facing away from said housing, said ball stud being adapted to be mounted to said component.

4. The ball joint according to claim 1, wherein said sealing bellows is provided with a metal ring which urges said sealing surface against said holding surface.

5. The ball joint according to claim 1, wherein said sealing bellows is dimensioned such that it can not slip off from said holding surface when said ball joint is not mounted to said component.
